(19) United States
(12) Patent Application Publication
(10) Pub. No.: US 2014/0196450 A1
(43) Pub. Date: Jul. 17, 2014

(54) ELECTRIC GENERATOR POWERED BY BUCKET CONVEYOR DRIVEN BY MASSIVE BUOYANT OBJECTS

(71) Applicants: Roger A. Boyd, Bryceville, FL (US); Danny W. Boyd, Baldwin, FL (US)

(72) Inventors: Roger A. Boyd, Bryceville, FL (US); Danny W. Boyd, Baldwin, FL (US)

(21) Appl. No.: 13/743,420

(22) Filed: Jan. 17, 2013

(51) Int. Cl. F03B 17/02

(52) U.S. Cl. CPC F03B 17/02
USPC 60/495

(57) ABSTRACT

An electric generation system includes a plurality of connected water filled chambers, each having a pivoting door that sequentially covers and exposes an access port through which buoyant objects travel to an ascending water filled tube leading to a bucket conveyor that drives a generator. The pivoting doors are synchronized so that one is opened while the other is closed. The doors are opened and closed by hemispherical cams driven by a motor. The pivoting doors propel buoyant objects towards the tube.

### FIELD OF THE INVENTION

This invention relates generally to electric generation, and, more particularly, to a system with a plurality of connected tanks each having a pivoting door that covers and exposes an access port through which buoyant objects travel to an ascending water filled tube leading to a bucket conveyor.

### BACKGROUND

Various generators powered by rotary objects driven by the weight of massive buoyant objects raised to a determined height in a buoyant tube are known. For example, several prior patents disclose systems that use buoyancy to lift a heavy buoyant object to an elevated height, where the object rolls onto an arm or into a cup extending from a wheel or conveyor. The weight of the ball then causes the wheel or conveyor to rotate, which drives an electric generator. Examples of prior patents and applications disclosing such electric generation systems include US 20060042244, JP-A-2002-138944, JP-A-H10-141204, and WO2007034502A1.

Means for repeatedly loading balls into the bottom of a water filled tube, without sacrificing the water, vary widely from system to system. For example, U.S. Pat. No. 5,944,480, US 20060042244 and JP-A-H10-141204 rely upon a vacuum effect, such as the effect achieved when a finger is placed over the top of a straw, to retain liquid in the tube while a port is opened at the bottom of the tube through which a buoyant object is introduced. JP-A-2002-138944 uses a contoured piston with a water-tight seal to slide balls into the tube.

US 20030151258 describes a system that uses a pair of spaced apart sliding doors to define an intermediate chamber. The doors operate similar to a breach door and muzzle door of a submarine torpedo tube. A first door slides open while the other door remains closed to provide access to the intermediate chamber without sacrificing liquid in the tube. The second door opens after the first door closes and the buoyant object is in the intermediate chamber. When the second door is opened, the buoyant objects floats from the intermediate chamber into the tube. This process repeats for each buoyant object. The patent describes programming to control actuators to automatically slide open and slide closed each door, according to a determined cycle. No mechanism is provided to propel

While these prior art systems may be useful for their intended purpose, they require complex equipment to maintain a vacuum, or complex equipment to independently operate doors and valves, and equipment that consumes considerable energy. Such systems are prone to failure and inefficiently consume a substantial portion of the generated energy. What is needed is a simpler, reliable, and more energy efficient system.

The invention is directed to overcoming one or more of the problems and solving one or more of the needs as set forth above.

### SUMMARY OF THE INVENTION

To solve one or more of the problems set forth above, in an exemplary implementation of the invention, an electric generation system according to principles of the invention, includes a plurality of connected water filled tanks, each having a pivoting door that covers and exposes an access port through which buoyant objects travel to an ascending water filled tube leading to a bucket conveyor. The plurality of tanks include an entry tank and a transitional tank. The transitional tank is fluidly coupled to the water filled tube. The pivoting doors are synchronized so that one is opened while the other is closed. When the door to the entry tank is opened, a buoyant object may enter the entry tank. As the door to the entry tank pivots closed, it urges the buoyant object towards the door to the transitional tank. When the door to the entry tank closes, the door to the transitional tank opens. The access port for the transitional tank is in the path of the buoyant object. After the buoyant object passes through the access port for the transitional tank, the door pivots closed. The pivoting door propels the buoyant object towards the tube. This process of each door, in turn, opening and then closing to propel the buoyant object without spilling any water from the tanks or tube is repeated for each buoyant object. After a buoyant object enters the tube it floats towards the surface. A subsequent buoyant object that floats toward the surface will help urge the uppermost buoyant object from the tube onto a chute that leads to the top receiving position of a bucket conveyor. The buoyant object rolls or slides from chute into a bucket of the bucket conveyor. The weight of the buoyant object drives the bucket conveyor. A gearbox and generator are mechanically coupled to the bucket conveyor. The bucket conveyor drives the generator, which produces electric power. At the bottom of the bucket conveyor, each bucket is emptied into a hopper or chute. The hopper or chute leads to the entry door of the entry tank.

The doors are sequentially opened and closed using a single motor and cams. A cam with a semicircular profile acts directly or indirectly upon each door. During half of the cycle the cam urges the door closed. During the other half of the cycle, the cam allows the door to open. The weight of the door cause the door to open when the cam is not urging it closed. One or more counterweights and/or springs may facilitate opening by urging the door into an open position. A single motor drives both cams.

Thus, the invention provides a closed loop system that continuously feeds buoyant objects to the top receiving position of a bucket conveyor that drives an electric generator. Only a single electric motor consumes power, which is a small fraction of the power generated by the system.

In a particular exemplary embodiment, an electric generation system according to principles of the invention includes a conveyor, a liquid-filled tank, a liquid filled buoyancy column, an inclined chute extending from the buoyancy column to about the conveyor, a plurality of buoyant objects and a generator assembly. Each of the buoyancy objects has an outer diameter and is buoyant in the liquid-filled tank and in the liquid filled buoyancy column, and having a mass sufficient to cause the conveyor to rotate. The conveyor includes an upper sprocket, a lower sprocket, a continuous chain engaging and entrained about the upper sprocket and the lower sprocket, and a plurality of carriers coupled to the continuous chain. The conveyor includes a descending side at which the carriers move in a downward direction from the upper sprocket to the lower sprocket. The conveyor also includes an ascending side at which the carriers move in an upward direction from the lower sprocket to the upper sprocket. Each of the plurality of carriers provides a surface for supporting one of the buoyant objects when the carrier is on the descending side. The liquid filled tank includes an entry chamber, an entry port, an entry door, a transitional chamber, a transitional port and a transitional door. The entry chamber is positioned below the lower sprocket. The entry port provides an opening through which a buoyant object enters the entry chamber. The entry door is hingedly mounted to the liquid filled tank. The entry door is pivotally movable from a closed position to an open position. In the closed position the entry door provides a watertight seal over the entry port. In the open position the entry door allows access for a buoyant object to pass through the entry port. The entry port is positioned to receive buoyant objects deposited from the conveyor. Pivoting motion of the entry door propels the buoyant object in the entry chamber towards the transitional chamber. The transitional chamber is in fluid communication with the entry chamber and positioned in a path of flow from the entry chamber to the transitional chamber. The transitional port provides an opening through which a buoyant object enters the transitional chamber from the entry chamber. The transitional door is hingedly mounted to the liquid filled tank. The transitional door is pivotally movable from a closed position to an open position. In the closed position the transitional door provides a watertight seal over the transitional port. In the open position the transitional door allowing access for a buoyant object to pass from the entry chamber into the transitional chamber through the transitional port. The transitional port is positioned to receive buoyant objects floating from the transitional chamber. Pivoting motion of the transitional door propels the buoyant object in the transitional chamber towards the buoyancy column. The buoyancy column is an elongated tubular container fluidly coupled to the transitional chamber and extending upwardly to a height above the chute. The buoyancy column has an outlet at a height about level with the chute. The buoyancy column is filled with a liquid (e.g., water) to about the outlet. The buoyancy column has an inner diameter that is greater than the outer diameter of each of the buoyancy objects. The chute extends from a position adjacent to the outlet of the buoyancy column to the descending side of the conveyor. A motor is operably coupled to the entry door via an entry door coupling and to the transitional door via a transitional door coupling. The motor causes the entry door to pivot open only when the transitional door is closed. The motor causes the transitional door to pivot open only when the entry door is closed. The motor causes the entry door to remain open for a first time duration sufficient to allow a buoyant object to enter the entry chamber. The motor causes the transitional door to remain open for a second time duration sufficient to allow a buoyant object to enter the transitional chamber from the entry chamber. The first duration is about equal to the second duration. The second duration repeatedly commences after the first duration. The first duration repeatedly commences after the second duration. The generator assembly includes an electric generator and a generator coupling rotatably connecting the electric generator to the conveyor.

Each of the buoyant objects may be a hollow sphere, including a sealable fill port providing access to an interior compartment of the hollow sphere and being used to partially fill the interior compartment with water. Each of the buoyant objects weighs between 200 to 500 pounds.

In a particular preferred embodiment, the entry door coupling includes a first cam with a hemispherical cross section shape and the transitional door coupling includes a second cam with a hemispherical cross section shape. The first cam is oriented to cause the entry door to pivot open only when the transitional door is closed. The second cam is oriented to cause the transitional door to pivot open only when the entry door is closed. The first cam and the second cam are rotatably driven by the motor. The first cam and second cam may act directly against the entry door and transitional door, respectively. Alternatively, the entry door coupling may include a first crank that is coupled to the entry door and against which the first cam acts. The transitional door coupling may include a second crank that is coupled to the transitional door and against which the second cam acts.

The buoyancy column may be substantially vertical or inclined.

The generator assembly may include a gearbox coupled to the electric generator between the generator coupling and electric generator. The gearbox converts a first rotational speed of the generator coupling to a second rotational speed input of the electric generator. The generator coupling may include a drive shaft, a continuous drive chain and a generator sprocket and/or a continuous drive belt and a generator pulley.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level schematic of an electric generator system powered by bucket conveyor driven by massive buoyant objects according to principles of the invention; and

FIG. 2 is a perspective view of an exemplary generator for a system according to principles of the invention; and

FIG. 3 is a schematic of an exemplary bucket conveyor for a system according to principles of the invention; and

FIG. 4 is a perspective view of an exemplary bucket conveyor for a system according to principles of the invention; and

FIG. 5 is a perspective view of a buoyant object for a system according to principles of the invention; and

FIG. 6 is a perspective view of half of a buoyant object for a system according to principles of the invention; and

FIG. 7 is a perspective view of bucket for a system according to principles of the invention; and

FIG. 8 is a perspective view of bucket holding a buoyant object for a system according to principles of the invention; and

FIG. 9 is a perspective view of tube and chute for a system according to principles of the invention; and

FIG. 10 is a first schematic of tanks and doors for a system according to principles of the invention; and

FIG. 11 is a second schematic of tanks and doors for a system according to principles of the invention; and

FIG. 12 is a third schematic of tanks and doors for a system according to principles of the invention; and

FIG. 13 is a side view of a motor and cams in a first position for a system according to principles of the invention; and

FIG. 14 is a perspective view of a motor and cams in a first position for a system according to principles of the invention; and

FIG. 15 is another perspective view of a motor and cams in a first position for a system according to principles of the invention; and

FIG. 16 is a perspective view of a section of tanks with doors in a first position for a system according to principles of the invention; and

FIG. 17 is another perspective view of a section of tanks with doors in a first position for a system according to principles of the invention; and

FIG. 18 is a side view of a motor and cams in a second position for a system according to principles of the invention; and

FIG. 19 is a perspective view of a motor and cams in a second position for a system according to principles of the invention; and

FIG. 20 is another perspective view of a motor and cams in a second position for a system according to principles of the invention; and

FIG. 21 is a perspective view of a section of tanks with doors in a second position for a system according to principles of the invention; and

FIG. 22 is another perspective view of a section of tanks with doors in a second position for a system according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

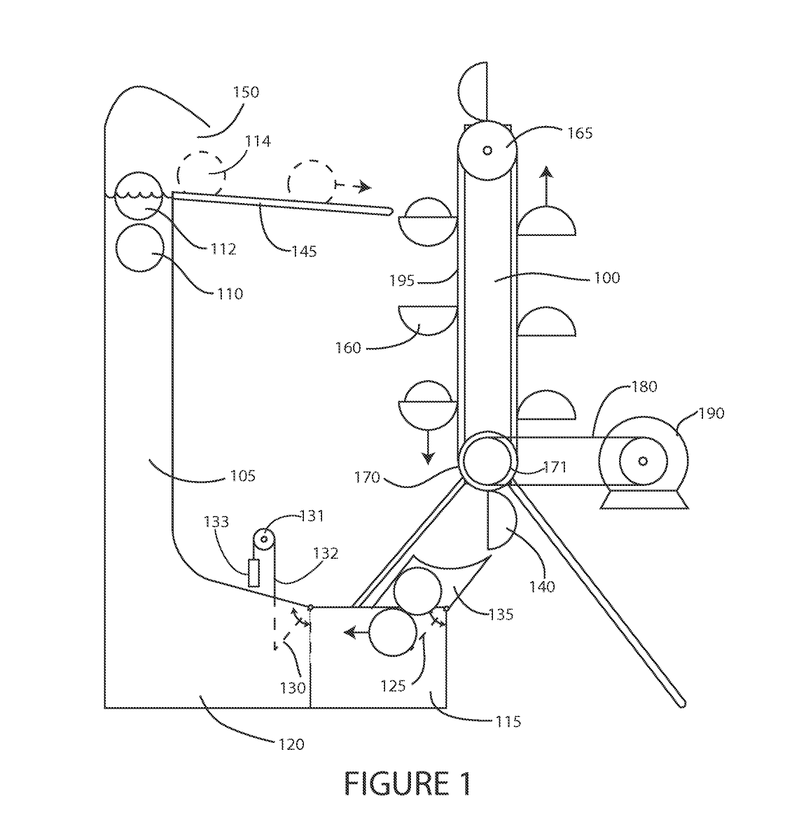

FIG. 1 is a high level schematic of an electric generator system powered by bucket conveyor driven by massive buoyant objects according to principles of the invention. Apparatus 100 is a bucket conveyor with a plurality of parallel chains driving upper and lower sprockets 165, 170. A plurality of buckets 160 are attached to the chains 195. On the receiving side of the conveyor 100, which is the side facing chute 145, the buckets receive heavy buoyant objects.110, 112, 114, after they roll or slide down the chute 145 into an available bucket 160. The weight of the heavy buoyant object causes the bucket to travel downwardly. When the bucket 160 reaches the bottom position 140, the bucket 160 pivots, thereby dumping the object into a chute or hopper 135 that leads to an entry tank 115 via an entry door 125.

In an exemplary embodiment, the buoyant objects are hollow balls, e.g., hollow steel balls. In a particular preferred embodiment, the balls are fillable steel balls, weighing between 200 to 500 pounds. An access port in the balls allows the balls to be partially filled with a liquid, such as water, to control the weight and buoyancy of the ball. The balls must be capable of floating up the water-filled buoyancy column 105. However, the invention is not limited to steel balls, or hollow steel balls, or balls. Any buoyant objects suitable for driving a bucket conveyor and progressing through a series of tanks as described below may be utilized. For convenience of reference, the buoyant objects are referred to herein as balls.

The entry door 125 and transitional door 130 provide water-tight seals when closed. They open and close by pivoting about a hinge. Gasket material may be provided along the edge of the door to provide a water-tight seal. The doors may be comprised of 1-inch steel plate, about 3 feet by 3 feet. One or more torsion springs or counterweights 133 may be provided to urge the doors open. The counterweights 133 may be coupled directly or indirectly to the door by a pulley 131 and lanyard 132. A cam, as described below urges each door 125, 130 closed temporarily. When a cam is not urging a door closed, the door opens under the influence of its own weight, and/or the counterweight and/or the torsion spring.

The entry door 125 opens enough to allow one buoyant object 110 to enter the entry tank 115 through the door 125. The entry tank 115 is filled with water. The weight of balls on top of the entering ball, force the entering ball below the water line. As the access door 125 closes, it urges the ball towards transitional tank 120. Additionally, if another ball enters the entry tank 115 while a ball is already in the entry tank 115, the second ball would urge the first ball towards the transitional tank 120.

The transitional tank 120 is a water-filled tank that extends between the entry tank and the buoyancy column. A pivoting door 130 over an access port allows access to the transitional tank 120 from the entry tank 115. The transitional tank door 130 opens only when the entry tank door 125 is closed. In that manner the water contained in buoyancy column 105 is not spilled. After the ball enters the transitional tank 120 the transitional door 130 closes. Only after the transitional door 130 closes, does the entry door 125 open to allow entry of another ball. A ball in the transitional tank floats towards the buoyancy column 105. The tank 120 may feature a sloping top to facilitate progression of the ball towards the column. Concomitantly, a second ball entering the transitional tank will urge the first ball to the buoyancy column 105.

The buoyancy column 105 is water filled column sized to receive the balls and allow them to float to a height above the receiving height of the bucket conveyor 100. Upon entering the buoyancy column 105, a ball floats to the top of the buoyancy column 105. An opening 150 at the top of the buoyancy column 105 is level with a portion of a chute 145. The ball 112 at top is urged above the water level onto the chute 145 by one or more balls 110 below it in the buoyancy column. The number of submerged balls required to urge a top ball onto a chute will vary depending upon buoyancies and weights. In some embodiments, two or more submerged balls may be required.

The chute 145 is an inclined channel, such as a trough or tube, for conveying balls from the top of the buoyancy column 105 to a lower level, i.e., the receiving height of the ball conveyor 100. The receiving height is a height at which a bucket 160 is positioned to receive a ball on the downward moving side of the bucket conveyor 100. Preferably, it is the maximum height for receiving a ball.

An electric generator 190 is mechanically coupled to and driven by the bucket conveyor. The coupling may be in the form of gears, belts and pulleys, chains and sprockets, drive shafts, and the like. By way of example and not limitation, chain 180 may be driven by a bottom sprocket 171 which may drive the generator. In this embodiment, the bottom sprocket 171 for driving the generator is separate from but connected to and rotates with the sprocket 170 for driving the conveyor chains 195.

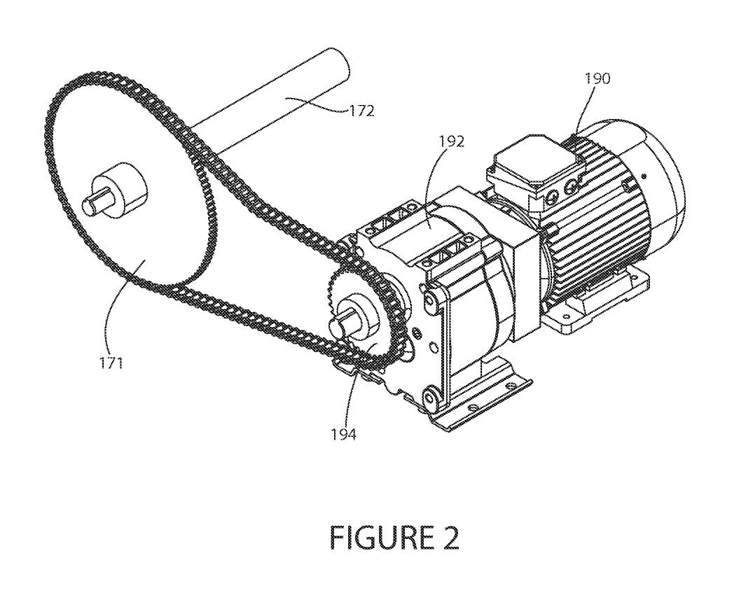

Referring now to FIG. 2, a perspective view of an exemplary generator assembly 190 for a system according to principles of the invention is provided. The generator 190 includes a gear box 192 configured to ensure adequate rotational speed for producing electricity. The gear ratio of the drive gear 194 and sprocket 171 may be varied to achieve a desired torque and rotational speed. By way of example and not limitation, many generators are designed to operate at 1800 or 3600 generator rotor rpm. Shaft 172 is coupled to the bottom sprocket 170 of the bucket conveyor. Other configurations within the scope of the invention may use a gear train, drive shaft or belts and pulleys to drive the gear box 192. Driving the bucket conveyor causes the shaft 172 to rotate, which causes the generator 190 to rotate.

The generator 190 may be any electric generator that converts mechanical energy to electrical energy, such as a conventional generator that produces direct current with the use of a commutator. The electrical energy may be stored, such as in batteries. The electrical energy may be metered. The electrical energy may be supplied to one or more loads, to circuits, and/or to a grid. Various electrical energy transmission and conversion devices may be interposed between the generator and the load. Such devices may include, without limitation, an inverter to convert DC to AC, battery charge regulation circuitry, and voltage regulators to maintain a determined voltage level. These and other electrical devices may be used to harness and efficiently transmit the generated electrical energy.

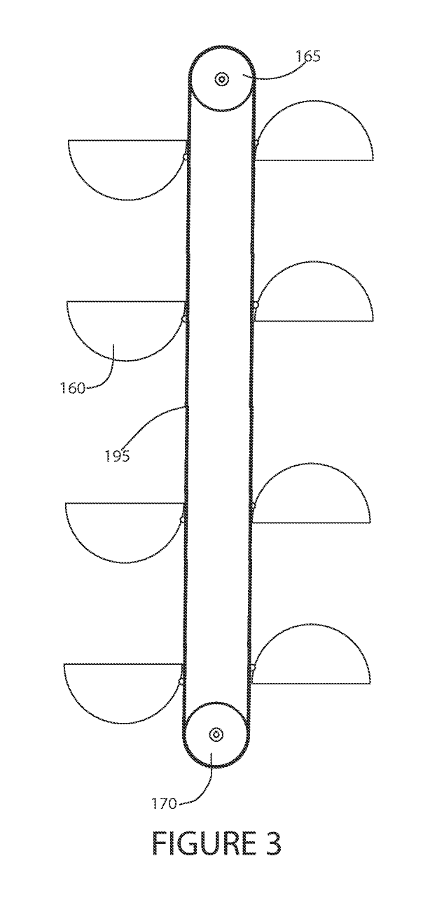

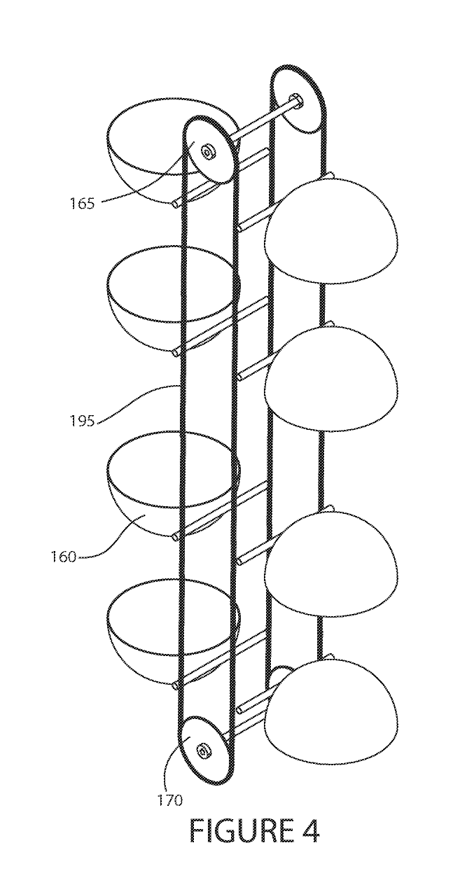

Referring now to FIGS. 3 and 4, schematics of an exemplary bucket conveyor for a system according to principles of the invention are shown. The generator drive gear 171 is omitted from these views. The bucket conveyor with a plurality of parallel chains drives upper and lower sprockets 165, 170. A plurality of buckets 160 are attached to the chains 195. On the receiving side of the conveyor 100, the concave compartment of the buckets faces upwardly. When the bucket 160 reaches the bottom position, the bucket 160 pivots, thereby dumping the object into a chute or hopper that leads to an entry tank via an entry door.

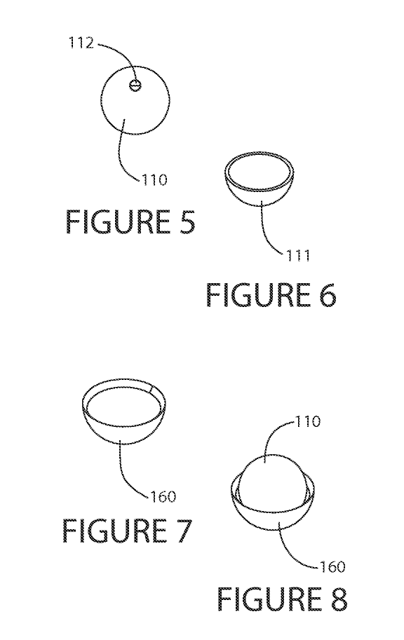

FIG. 5 provides a perspective view of a buoyant object for a system according to principles of the invention. The buoyant object is a hollow ball 110, as illustrated by the perspective view of half 111 of the ball in FIG. 6. A threaded removable plug 112 seals an access port that allows the ball 110 to be partially filled with a liquid. When screwed in place, the outer surface of the plug 112 is substantially flush with the outer surface of the ball 110. In this manner, the plug 112 does not interfere with smooth rolling or sliding motion of the ball. In an exemplary embodiment, the balls 110 are fillable steel balls, weighing between 200 to 500 pounds. The balls are capable of floating up the water-filled buoyancy column 105. However, the invention is not limited to steel balls, or hollow steel balls, or balls. Instead, any buoyant objects suitable for driving a bucket conveyor and progressing through a series of tanks as described below may be utilized.

FIG. 7 provides a perspective view of an empty exemplary bucket 160 for a system according to principles of the invention. FIG. 8 shows the bucket 160 containing a ball 110. As is shown, the exemplary bucket provides a concave compartment into which the ball may rest. However, the invention is not limited to such geometries. Any structure capable of holding a ball along the downward path of the conveyor may be utilized. By way of example and not limitation, inclined planar shelves that hold the balls adjacent to the chain may be utilized in lieu of bucket-like containers, without departing from the scope of the invention.

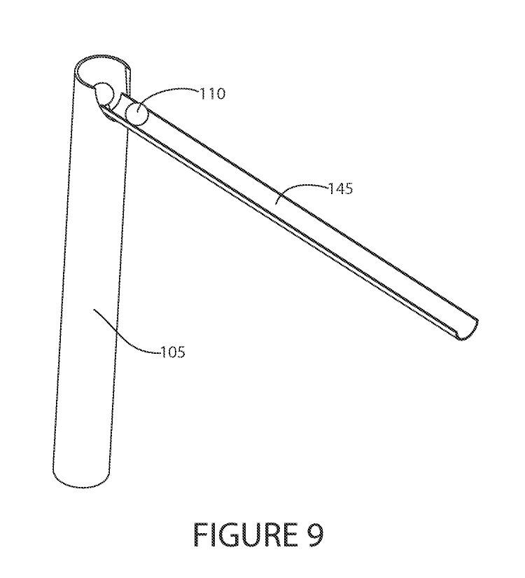

FIG. 9 is a perspective view of buoyancy column 105 and a chute 145 for a system according to principles of the invention. An opening 150 at the top of the buoyancy column 105 is level with a portion of the chute 145. A ball that has floated to the top of the buoyancy column is urged above the water level onto the chute 145 by one or more balls below it in the buoyancy column. The number of submerged balls required to urge a top ball onto a chute will vary depending upon buoyancies and weights. In some embodiments, two or more submerged balls may be required. The chute 145 is an inclined channel, such as a trough or tube, for conveying balls from the top of the buoyancy column 105 to a lower level, i.e., the receiving height of the ball conveyor 100. The receiving height is a height at which a bucket 160 is positioned to receive a ball on the downward moving side of the bucket conveyor 100. Preferably, it is the maximum height for receiving a ball. On the receiving side of the conveyor 100, which is the side facing chute 145, the buckets receive heavy buoyant objects 110, 112, 114, after they roll or slide down the chute 145 into an available bucket 160. The weight of the heavy buoyant object then causes the bucket to travel downwardly.

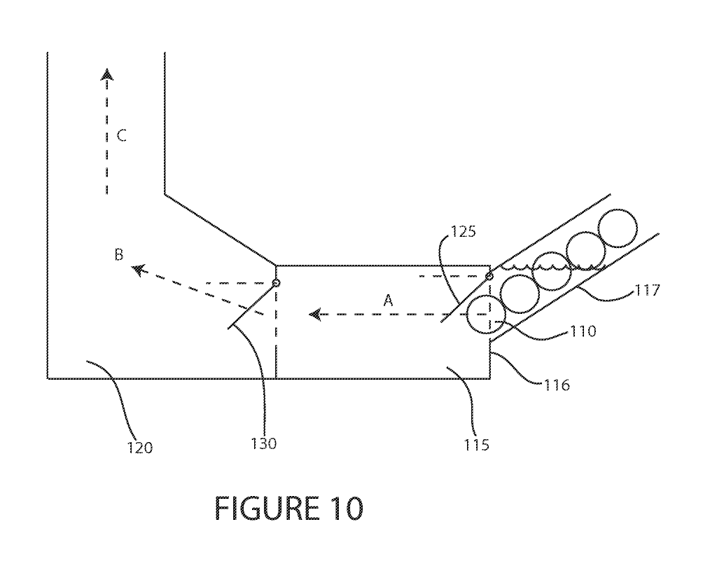

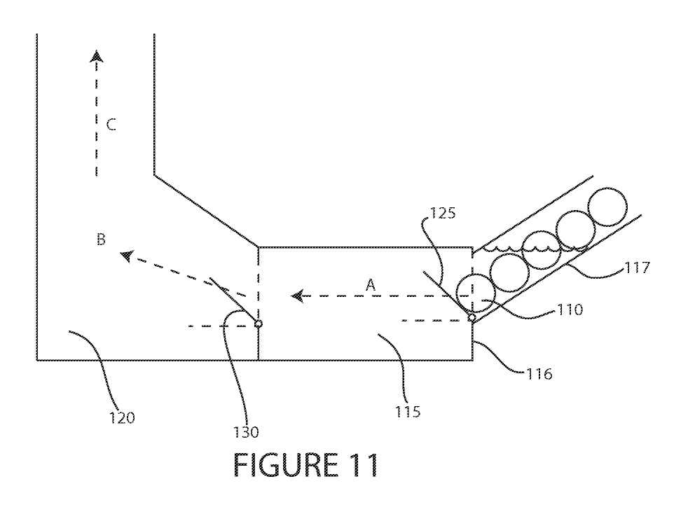

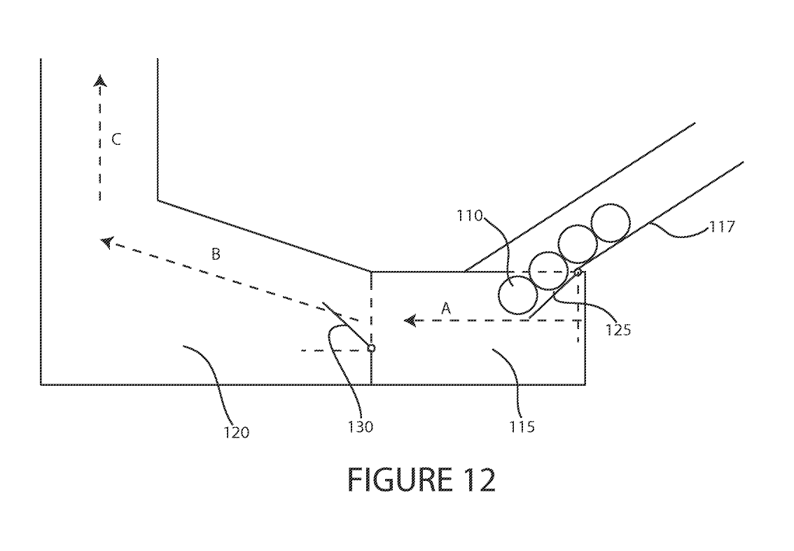

FIGS. 10 through 12 provide schematics of tanks and doors for a system according to principles of the invention. The different figures illustrate different door arrangements. For example, in FIG. 10, the entry door 125 and transitional door 130 are on side panels of the tanks 115, 120, hinged along their top edges. A chute 117 leads balls into an access port in the side panel of the entry tank 115 when the entry door is opened. In FIG. 11, the entry door 125 and transitional door 130 are on side panels of the tanks 115, 120, but hinged along their bottom edges. A chute 117 leads balls into an access port in the side panel of the entry tank 115 when the entry door is opened. In an alternative arrangement, as in FIG. 12, the entry door 125 is on top of the entry tank 110 and the transitional door 130 is on a side panel. Again, a chute 117 delivers balls to the entry door access when the entry door 125 is opened. These and other arrangements of an entry door 125 and transitional door 130 are possible, and come within the scope of the invention.

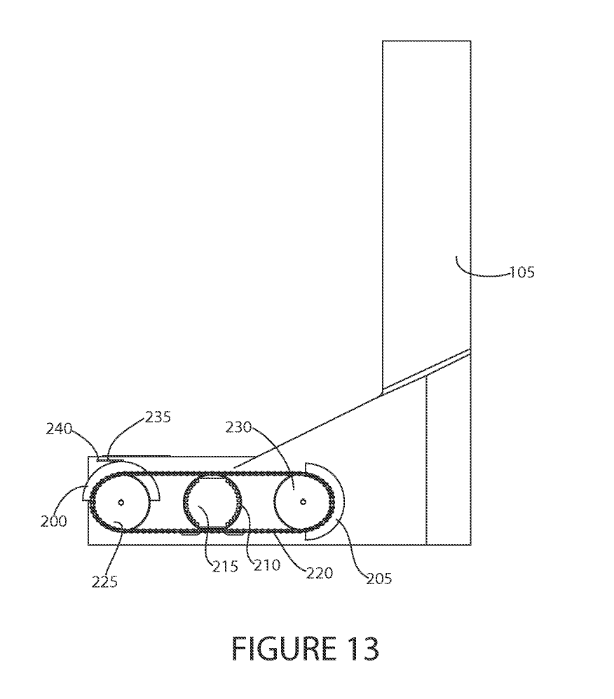

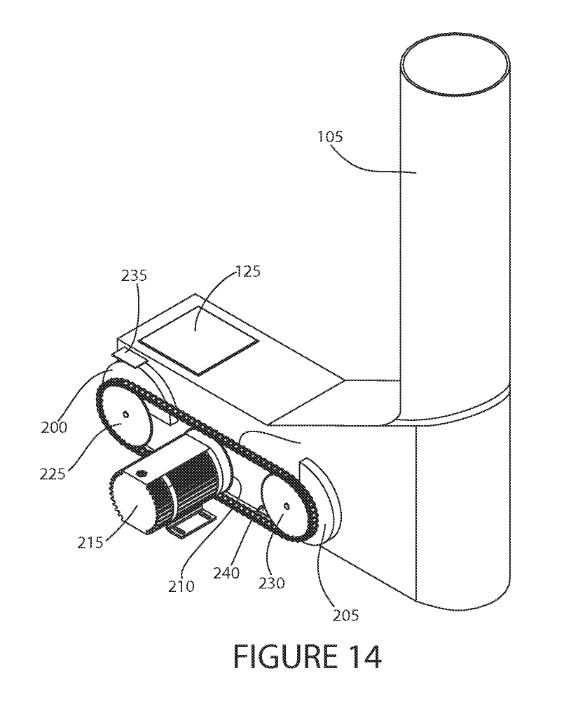

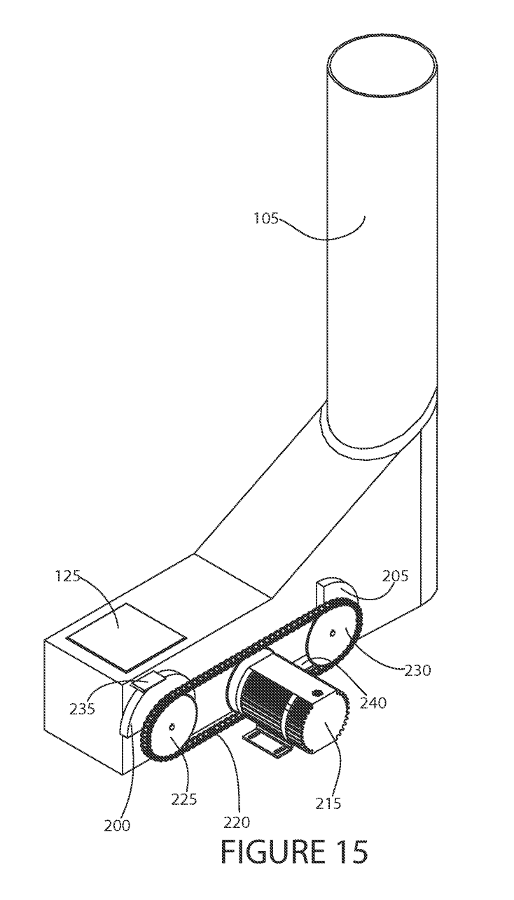

FIGS. 13 through 15 provide various views of a motor and cams in a first position for a system according to principles of the invention. In FIGS. 13-15, the entry door 125 is shown urged closed while the transitional door 130 is opened. The motor 215 is an electric motor that drives the cams 200, 205. By way of example and not limitation, the motor 215 may be a 6V, 12V or 24V DC motor. The chain 220 is entrained on sprockets 210, 225, 230. The motor 215 thereby causes the cams 200 to rotate. In this exemplary embodiment, a chain drive 220 couples the motor 215 to cam drive sprockets 225, 230. Other rotary linkages such as drive shafts, gear trains, belts and pulleys and combinations thereof to drive both cams 200, 205 at the same rotational rate with a single motor 215, without departing from the scope of the invention.

Each cam 200, 205 comprises a semicircular lobe (i.e., a lobe having a semicircular cross section shape) that urges a door 125, 130 closed. In one embodiment, the cams 200, 205 act upon crank arms 235, 242 that are coupled to the pivot pins of the door hinges. Pivoting rotation of the crank arms 235, 242, about their respective crank shafts 240, 243, causes the doors 125, 130 to correspondingly pivot, such as from an open position to a closed position. To facilitate rotation and prevent leakage, bearings and seals may be provided in or against the walls of the tanks, at openings through which the crank shafts 240, 243 extend.

In a preferred embodiment, the cams are used to urge the doors 125, 130 closed. A door may open under the influence of gravity when a cam is not urging the door closed. In the exemplary embodiment, a cam urges a door closed by acting on a crank arm coupled to the door. In another embodiment, the cams may be in the tank and act directly on the doors. Additionally, one or more torsion springs or counterweights 133 (FIG. 1) may be provided to help urge the doors open. The counterweights 133 may be coupled directly or indirectly to the door by a pulley 131 and lanyard 132. When a cam 200, 205 is not urging a door closed, the door opens under the influence of its own weight, and/or the counterweight and/or the torsion spring.

The cam timing is set to allow a door to open only for half of a cycle and only when the other door is closed. The semicircular cams 200, 205 are oriented to act on each door for half of a cycle. A cycle is a complete rotation of each cam. The cams 200, 205 are configured to rotate at the same rate. One cam 200 acts on one door 125, causing the door 125 to remain closed, while the other cam 205 allows the other door 130 to open. The other cam 205 acts on the other door 130, causing the other door to remain closed, while the first cam 20o allows the entry door 125 to open. Each door 125, 135 remains open for half of a cycle and closed for half of a cycle. Based upon the preferred configuration, the entry door 125 is closed, the entire time the transitional door 130 is open. Also, based upon the preferred configuration, the entry door 125 is open, the entire time the transitional door 130 is closed. In this manner, the two doors 125, 130 are never open at the same time. Consequently, the water contained in the buoyancy column 105 does not spill out of the tanks 115, 120 through the open doors.

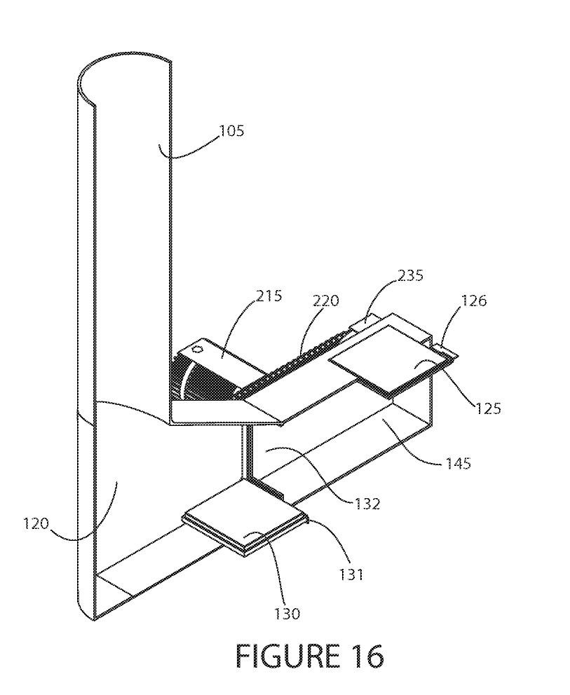

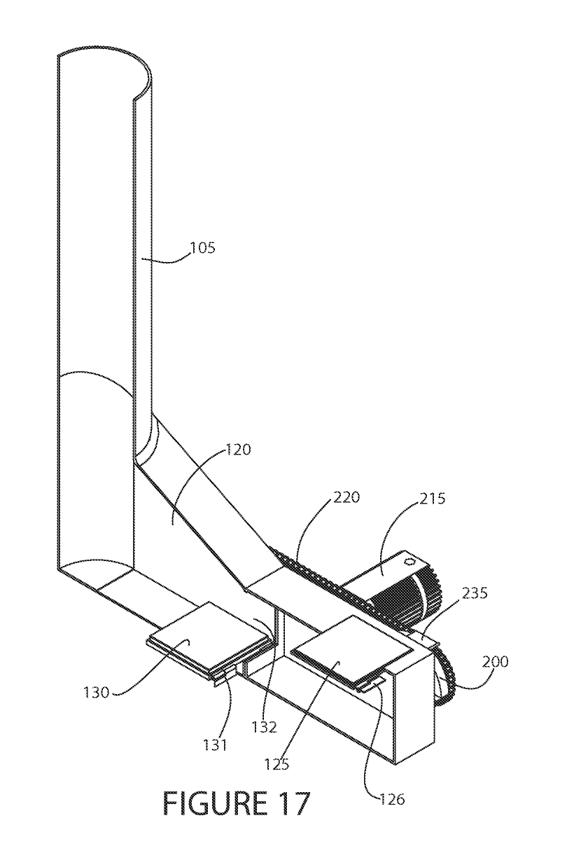

Referring now to FIGS. 16, 17, perspective views of a section of tanks with doors in a first position for a system according to principles of the invention is shown. The entry door 125 is urged closed (as shown in FIGS. 13-15) while the transitional door 130 is opened. Thus, the closed entry door 125 prevents water from spilling out of the system. The opened transitional door 130 allows a ball to float from the entry tank 115 into the transitional tank, towards the buoyancy column 105.

The pivoting doors act as paddles, propelling the balls. Opening and closing motion of the doors provides a paddling effect that propels floating balls from the entry tank 115 to the transitional tank 120 and then to the buoyancy column 105.

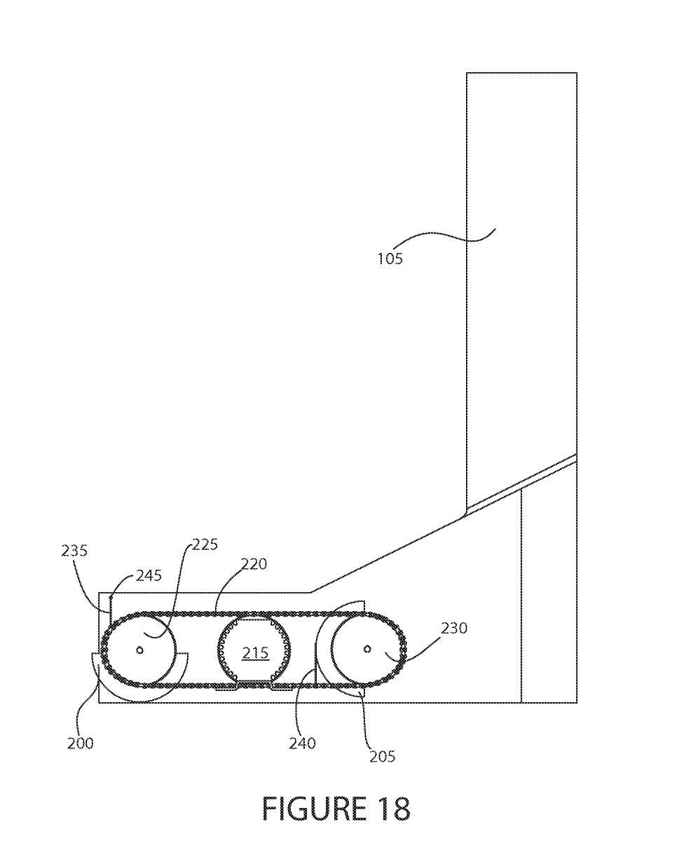

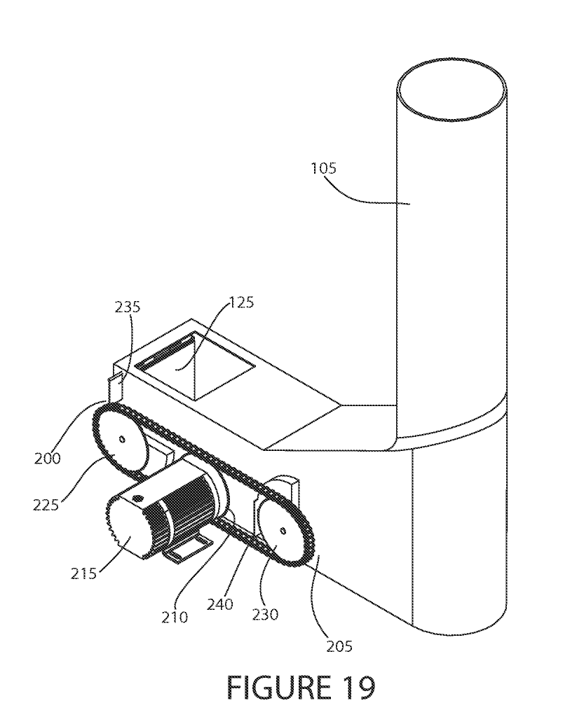

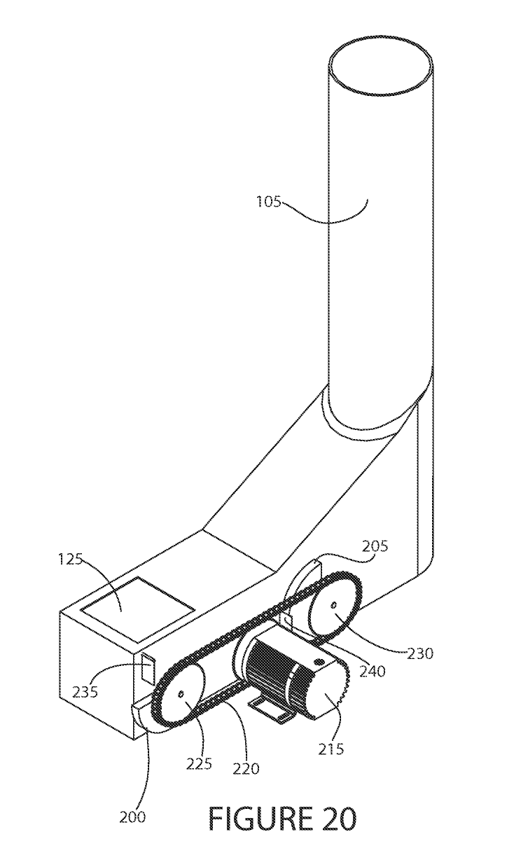

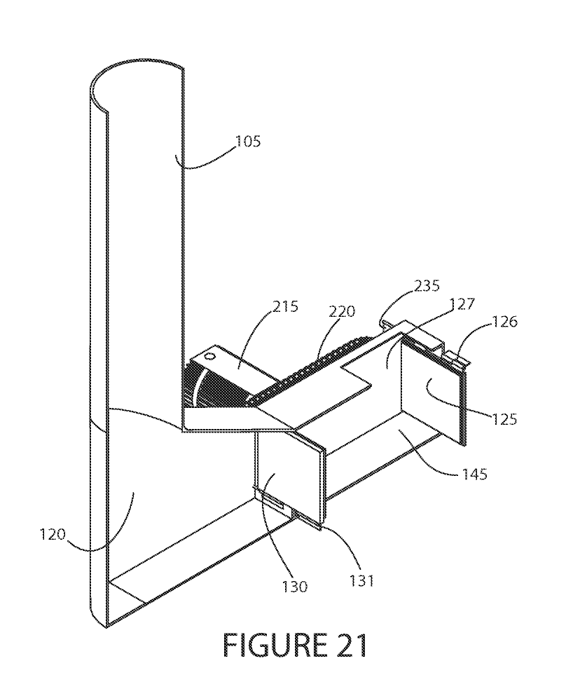

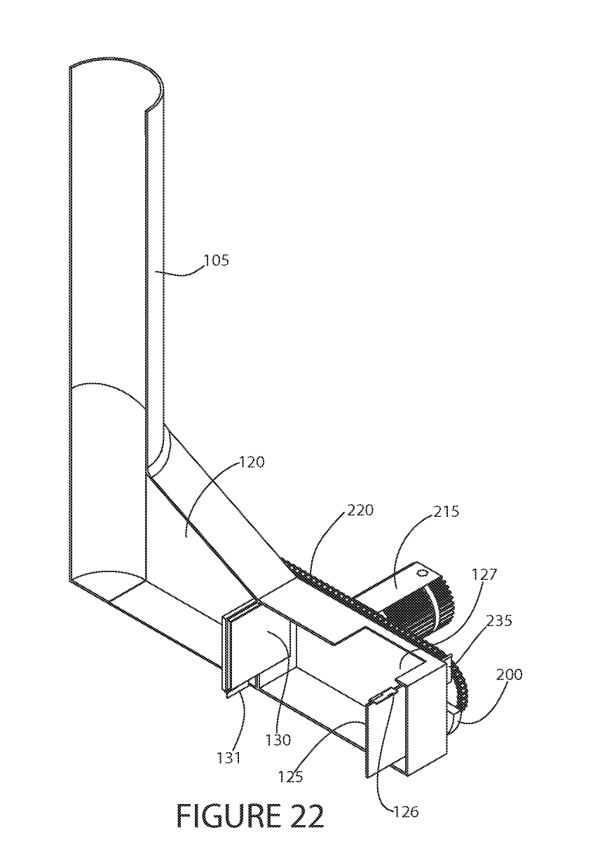

FIGS. 18 through 20 provide various views of a motor and cams in a second position for a system according to principles of the invention. In FIGS. 18-20, the entry door 125 is shown opened while the transitional door 130 is closed (as shown in FIGS. 21 and 22).

The cams are used to urge the transitional door 130 closed while the entry door is not urged closed and allowed to open. A door may open under the influence of gravity when a cam is not urging the door closed. In the exemplary embodiment, a cam urges a door closed by acting on a crank arm coupled to the door. In another embodiment, the cams may be in the tank and act directly on the doors. Additionally, one or more torsion springs or counterweights 133 (FIG. 1) may be provided to help urge the doors open. The counterweights 133 may be coupled directly or indirectly to the door by a pulley 131 and lanyard 132. When a cam 200, 205 is not urging a door closed, the door opens under the influence of its own weight, and/or the counterweight and/or the torsion spring. Based upon the preferred configuration, the entry door 125 is open, the entire time the transitional door 130 is closed. In this manner, the two doors 125, 130 are never open at the same time. Consequently, the water contained in the buoyancy column 105 does not spill out of the tanks 115, 120 through the open doors.

Referring now to FIGS. 21, 22, perspective views of a section of tanks with doors in a second position for a system according to principles of the invention is shown. The entry door 125 is opened (as shown in FIGS. 18-20) while the transitional door 130 is urged closed. Thus, the closed transitional door 130 prevents water from spilling out of the system. The opened entry door 125 allows a ball to enter the entry tank 115 from where it can subsequently drift into the transitional tank 120 when the transitional door 130 opens and the entry door 125 closes.

The pivoting doors act as paddles, propelling the balls. Opening and closing motion of the doors provides a paddling effect that propels floating balls from the entry tank 115 to the transitional tank 120 and then to the buoyancy column 105.

A system according to principles of the invention may operate continuously so long as the mechanical components continue to operate. A system according to principles of the invention is scalable. The heights of the buoyancy column and conveyor, the number and mass of balls, and the size of the generator, may be sized to achieve a desired output. Additionally, the cycle time of the cams may be increased or decreased by adjusting the rotational speed of the driving motor. Furthermore, the size of the cams may be adjusted to vary cycle times.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. An electric generation system comprising a conveyor, a liquid-filled tank, a liquid filled buoyancy column, an inclined chute extending from the buoyancy column to about the conveyor, a plurality of buoyant objects and a generator assembly;
each of said buoyancy objects being objects having an outer diameter and being buoyant in the liquid-filled tank and in the liquid filled buoyancy column, and having a mass sufficient to cause the conveyor to rotate; and
said conveyor comprising an upper sprocket, a lower sprocket, a continuous chain engaging and entrained about the upper sprocket and the lower sprocket, a plurality of carriers coupled to the continuous chain, said conveyor including a descending side at which the carriers move in a downward direction from the upper sprocket to the lower sprocket, said conveyor also including an ascending side at which the carriers move in an upward direction from the lower sprocket to the upper sprocket, each of said plurality of carriers providing a surface for supporting one of the buoyant objects when the carrier is on the descending side; and
said liquid filled tank including an entry chamber, an entry port and an entry door, and a transitional chamber, a transitional port and a transitional door, the entry chamber being positioned below the lower sprocket, the entry port providing an opening through which a buoyant object enters the entry chamber, the entry door being hingedly mounted to the liquid filled tank, the entry door being pivotally movable from a closed position to an open position, and in the closed position the entry door providing a watertight seal over the entry port, and in the open position the entry door allowing access for a buoyant object to pass through the entry port, and the entry port being positioned to receive buoyant objects deposited from the conveyor, and pivoting motion of the entry door propelling the buoyant object in the entry chamber towards the transitional chamber; and
said transitional chamber being in fluid communication with the entry chamber and positioned in a path of flow from the entry chamber to the transitional chamber, the transitional port providing an opening through which a buoyant object enters the transitional chamber from the entry chamber, the transitional door being hingedly mounted to the liquid filled tank, the transitional door being pivotally movable from a closed position to an open position, in the closed position the transitional door providing a watertight seal over the transitional port, and in the open position the transitional door allowing access for a buoyant object to pass from the entry chamber into the transitional chamber through the transitional port, and the transitional port being positioned to receive buoyant objects floating from the transitional chamber, and pivoting motion of the transitional door propelling the buoyant object in the transitional chamber towards the buoyancy column; and
said buoyancy column being an elongated tubular container fluidly coupled to the transitional chamber and extending upwardly to a height above the chute, and said buoyancy column having an outlet at a height about level with the chute, and said buoyancy column being filled with a liquid to about the outlet, and said buoyancy column have an inner diameter that is greater than the outer diameter of each of the buoyancy objects; and
said chute extending from a position adjacent to the outlet of the buoyancy column to the descending side of the conveyor; and
a motor operably coupled to the entry door via an entry door coupling and to the transitional door via a transitional door coupling, said motor causing the entry door to pivot open only when the transitional door is closed, and said motor causing the transitional door to pivot open only when the entry door is closed, and said motor causing the entry door to remain open for a first time duration sufficient to allow a buoyant object to enter the entry chamber, and said motor causing the transitional door to remain open for a second time duration sufficient to allow a buoyant object to enter the transitional chamber from the entry chamber, and said first duration being about equal to the second duration, and said second duration repeatedly commencing after the first duration, and said first duration repeatedly commencing after the second duration; and
said generator assembly comprising an electric generator and a generator coupling rotatably connecting the electric generator to the conveyor.

2. An electric generation system according to claim 1, each of said buoyant objects comprising a hollow sphere.

3. An electric generation system according to claim 2, each of said hollow spheres including a sealable fill port providing access to an interior compartment of the hollow sphere, said fill port being used to partially fill the interior compartment with water.

4. An electric generation system according to claim 1, each of said buoyant objects weighing between 200 to 500 pounds.

5. An electric generation system according to claim 1, said entry door coupling comprising a first cam with a hemispherical cross section shape, and said transitional door coupling comprising a second cam with a hemispherical cross section shape, and said first cam being oriented to cause the entry door to pivot open only when the transitional door is closed, and said second cam being oriented to cause the transitional door to pivot open only when the entry door is closed, and said first cam and said second cam being rotatably driven by the motor.

6. An electric generation system according to claim 5, said first cam acting against the entry door and said second cam acting against the transitional door.

7. An electric generation system according to claim 5, said entry door coupling further comprising a first crank coupled to the entry door and said first cam acting against the first crank.

8. An electric generation system according to claim 7, said transitional door coupling further comprising a second crank coupled to the entry door and said second cam acting against the second crank.

9. An electric generation system according to claim 1, said buoyancy column being substantially vertical.

10. An electric generation system according to claim 1, said buoyancy column being inclined.

11. An electric generation system according to claim 1, said generator assembly comprising a gearbox coupled to the electric generator between the generator coupling and electric generator, said gearbox converting a first rotational speed of the generator coupling to a second rotational speed input of the electric generator.

12. An electric generation system according to claim 11, said generator coupling comprising a drive shaft.

13. An electric generation system according to claim 11, said generator coupling comprising a continuous drive chain and a generator sprocket.

14. An electric generation system according to claim 11, said generator coupling comprising a continuous drive belt and a generator pulley.

15. An electric generation system according to claim 1, each of said buoyant objects comprising a hollow sphere, each of said hollow spheres including a sealable fill port providing access to an interior compartment of the hollow sphere, said fill port being used to partially fill the interior compartment with water, and each of said hollow spheres weighing between 200 to 500 pounds.

16. An electric generation system according to claim 15, said entry door coupling comprising a first cam with a hemispherical cross section shape, and said transitional door coupling comprising a second cam with a hemispherical cross section shape, and said first cam being oriented to cause the entry door to pivot open only when the transitional door is closed, and said second cam being oriented to cause the transitional door to pivot open only when the entry door is closed, and said first cam and said second cam being rotatably driven by the motor.

17. An electric generation system according to claim 16, said buoyancy column being substantially vertical.

18. An electric generation system according to claim 16, said buoyancy column being inclined.

19. An electric generation system according to claim 16, said generator assembly comprising a gearbox coupled to the electric generator between the generator coupling and electric generator, said gearbox converting a first rotational speed of the generator coupling to a second rotational speed input of the electric generator.

20. An electric generation system according to claim 19, said generator coupling comprising a rotational transmission from the group consisting of a drive shaft, a continuous drive chain and a generator sprocket, and a continuous drive belt and a generator pulley.
